(19) United States
(12) Patent Application Publication
(10) Pub. No.: US 2023/0328191 A1
(43) Pub. Date: Oct. 12, 2023

(54) INFORMATION OUTPUT SYSTEM, INFORMATION OUTPUT METHOD, AND RECORDING MEDIUM STORING INFORMATION OUTPUT PROGRAM

(71) Applicant: KONICA MINOLTA, INC., Tokyo (JP)

(72) Inventor: Keitaro OURA, Osaka (JP)

(73) Assignee: KONICA MINOLTA, INC., Tokyo (JP)

(21) Appl. No.: 18/296,592

(22) Filed: Apr. 6, 2023

(30) Foreign Application Priority Data
Apr. 12, 2022 (JP) 2022-065553

(51) Int. Cl. H04N 1/00

(52) U.S. Cl. CPC H04N 1/00912; H04N 1/00127; H04N 2201/0094

(57) ABSTRACT

An information output system includes an acquisition section that acquires care-related information of a facility, a hardware processor that calculates predetermined information required in the event of a disaster based on the care-related information and causes an output section to output the information required in the event of the disaster when the disaster occurs.

### CROSS-REFERENCE TO RELATED APPLICATION

Japanese patent application No. 2022-065553 filed on Apr. 12, 2022, including description, claims, drawings, and abstract the entire disclosure is incorporated herein by reference in its entirety.

### BACKGROUND

### 1. Technological Field

The present invention relates to an information output system, an information output method, and recording medium storing an information output program.

### 2. Description of the Related Art

In a facility such as a welfare facility for the aged or a hospital, in order to effectively utilize limited resources at the time of occurrence of a disaster such as a natural disaster, a task having higher priority is selected. Some of these tasks are directly linked to the lives of residents of the facility and the like.

Generally, information related to care such as nursing care and nursing in a facility is very huge and is often managed on a server. At the time of evacuation due to the occurrence of a disaster, there is a demand for quickly securing minimum necessary information for carrying out a prioritized task.

On the other hand, some facilities store the minimum necessary information as paper media. In such facilities, since administrators of individual information are different and all employees do not know the location of information in some cases, it takes time to collect minimum necessary information when a disaster occurs.

The following prior art is disclosed in Unexamined Japanese Patent Publication No. 2011-248070. Upon reception of an emergency earthquake prompt report, a multi-function peripheral determines whether or not emergency printing for printing predetermined evacuation information can be performed by the time of arrival of the earthquake at the installation place of the multi-function peripheral and performs the emergency printing if the emergency printing can be performed. Accordingly, since the emergency printing can be completed before the arrival of the earthquake, it is possible to acquire the evacuation information as a printed matter before the arrival of the earthquake as well as avoiding an operation error or a failure that occurs due to a printing operation performed when the earthquake arrives.

### SUMMARY

However, the prior art disclosed in Unexamined Japanese Patent Publication No. 2011-248070 has a problem in that it is not possible to respond to a demand for quickly securing minimum information necessary for performing tasks when a disaster occurs.

The present invention has been made to solve such problems. That is, an object of the present invention is to provide an information output system, an information output method, and an information output program which can quickly ensure the minimum necessary information for performing a prioritized task in the event of a disaster and support the continuity of care service and quick evacuation.

To achieve at least one of the abovementioned objects, according to an aspect of the present invention, an information output system reflecting one aspect of the present inventions comprises the followings.

An information output system includes an acquisition section that acquires care-related information of a facility, and a hardware processor that calculates predetermined information required in the event of a disaster based on the acquired care-related information and causes an output section to output the calculated information required in the event of the disaster when the disaster occurs.

An information output method includes a step (a) of acquiring care-related information of a facility, a step (b) calculating predetermined information required in the event of a disaster based on the acquired care-related information, and a step (c) outputting the calculated information required in the event of the disaster when the disaster occurs.

An information output program causes a computer to execute a step (a) of acquiring care-related information of a facility, a step (b) calculating predetermined information required in the event of a disaster based on the acquired care-related information, and a step (c) outputting the calculated information required in the event of the disaster when the disaster occurs.

The objects, features, and characteristics of this invention other than those set forth above will become apparent from the description given herein below with reference to preferred embodiments illustrated in the accompanying drawings.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention.

FIG. 1 is a diagram showing the overall configuration of an information output system;

FIG. 2 is a block diagram illustrating the hardware configuration of an image forming apparatus;

FIG. 3 is a schematic diagram illustrating the configuration of an image forming apparatus;

FIG. 4 is a block diagram illustrating functions of a controller;

FIG. 5 is a diagram illustrating a resident table;

FIG. 6 is a diagram illustrating a medication table;

FIG. 7 is a diagram illustrating a diet table;

FIG. 8 is a diagram showing a work shift table of care staff;

FIG. 9 is a block diagram illustrating the hardware configuration of a server; and

FIG. 10 is a flowchart showing the operation of the image forming apparatus.

### DETAILED DESCRIPTION OF EMBODIMENTS

Hereinafter, one or more embodiments of the present invention will be described with reference to the drawings. However, the scope of the invention is not limited to the disclosed embodiments.

An information output system, an information output method, and an information output program according to an embodiment of the present invention will be described below with reference to the accompanying drawings. In the drawings, the same components are denoted by the same reference numerals, and overlapping description will be omitted. In addition, dimensional ratios in the drawings are exaggerated for convenience of explanation and may be different from actual ratios.

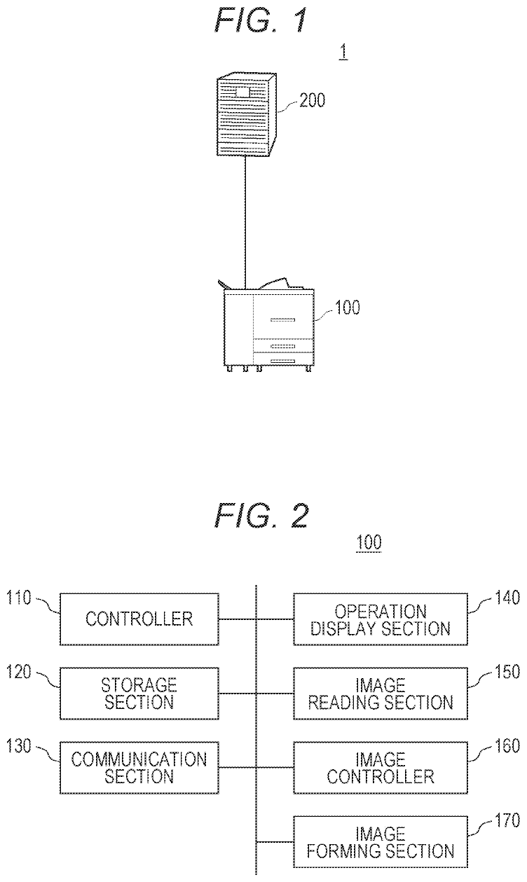

FIG. 1 is a diagram showing the overall configuration of an information output system 1 according to the present embodiment. The information output system 1 used in a facility where care, nursing care, or the like is performed (hereinafter also referred to simply as a “facility”) includes an image forming apparatus 100 and a server 200. The information output system 1 may include only the image forming apparatus 100. The image forming apparatus 100 and the server 200 can be communicably connected to each other via a local area network (LAN). The image forming apparatus 100 may be replaced with a computer such as a terminal.

(Image Forming Apparatus 100)

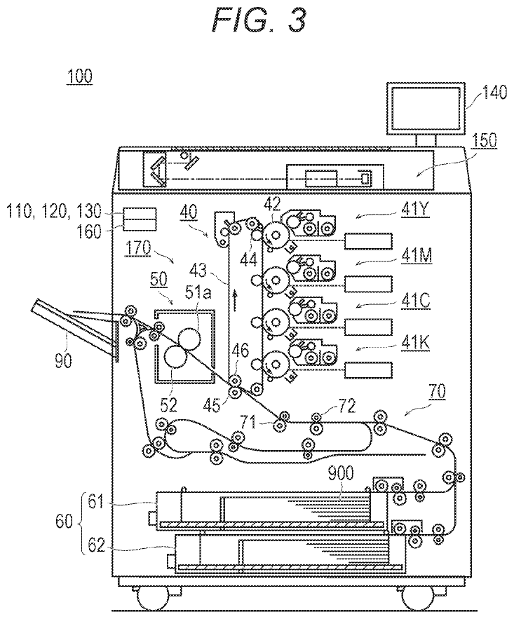

FIG. 2 is a block diagram illustrating the hardware configuration of the image forming apparatus 100. FIG. 3 is a schematic diagram illustrating the configuration of the image forming apparatus 100.

The image forming apparatus 100 includes a controller 110, a storage section 120, a communication section 130, an operation display section 140, an image reading section 150, an image controller 160, and an image forming section 170. These constituent elements are communicatively coupled to each other via a bus. The Image forming apparatus 100 may be implemented by a multifunction peripheral (MFP).

The controller 110 includes a CPU (Central Processing Unit) and various memories and performs control of each unit described above and various types of arithmetic processing according to programs. The details of the working of the controller 110 will be described later.

The storage section 120 is formed from a solid state drive (SDD), a hard disc drive (HDD), or the like and stores various programs and various types of data.

The communication section 130 is an interface for enabling communication between the image forming apparatus 100 and an external device. As the communication section 130, a network interface based on a standard such as Ethernet (registered trademark), SATA, or IEEE1394 is used. As the communication section 130, various kinds of local connection interfaces including wireless communication interfaces such as Bluetooth (registered trademark) and IEEE802.11 and the like may be used.

The operation display section 140 includes a touch panel, a ten-key pad, a start button, and a stop button and is used for displaying various kinds of information and inputting various instructions.

The image reading section 150 includes a light source such as a fluorescent lamp and an imaging element such as a charge coupled device (CCD) image sensor. The image reading section 150 irradiates a document set at a predetermined reading position with light from a light source, photoelectrically converts reflected light by an imaging element, and generates image data from the electric signal.

The image controller 160 performs layout and rasterization of the print data included in the print job and the like received from the communication section 130 and generates image data in a bitmap format.

The print job is a generic name for a printing instruction to be given to the image forming apparatus 100 and includes print data and print settings. Print data is the data of a document to be printed and can include, for example, various kinds of data such as image data, vector data, and text data. Specifically, print data may be page description language (PDL) data, portable document format (PDF) data, or tagged image file format (TIFF) data. Print settings are settings related to the formation of an image on a sheet 900 and includes, for example, various settings such as the number of pages, the number of copies, a paper type, selection of color or monochrome, and page allocation.

The image forming section 170 includes an imaging section 40, a fixing section 50, a sheet feed section 60, and a sheet conveyance section 70.

The imaging section 40 includes imaging units 41Y, 41M, 41C, and 41K corresponding to toners of respective colors of Y (yellow), M (magenta), C (cyan), and K (black). Each of the imaging units 41Y 41M, 41C, and 41K forms a toner image on a photosensitive drum 42 based on image data through processes of charging, exposure, and development. Exposure is performed by scanning the surface of the photosensitive drum 42 with a laser beam. The toner images formed on the photosensitive drums 42 are sequentially superimposed and primarily transferred onto an intermediate transfer belt 43 by an electrostatic force generated by a transfer voltage controlled to be a constant voltage and applied to a primary transfer roller 44. Thus, a color toner image is held on the intermediate transfer belt 43. The color toner image on the intermediate transfer belt 43 is secondarily transferred onto the sheet 900 by a secondary transfer roller 45.

The fixing section 50 includes a fixing roller 51a and a pressure roller 52, and the fixing roller 51a and the pressure roller 52 are brought into pressure contact with each other, thereby forming a fixing nip between the fixing roller 51a and the pressure roller 52. The fixing section 50 heats and pressurizes, at the fixing nip, the sheet 900 conveyed to the fixing nip and rotates the fixing roller 51a and the pressure roller 52, thereby fusing and fixing the toner image on the surface of the sheet 900.

The sheet feed section 60 includes a plurality of sheet feed trays 61 and 62 and sends out the sheet 900 stored in the sheet feed trays 61 and 62 one by one to a sheet conveyance path on the downstream side.

The sheet conveyance section 70 includes a plurality of conveyance rollers for conveying the sheet 900 and conveys the sheet 900 among the imaging section 40, the fixing section 50, and the sheet feed section 60. The plurality of conveyance rollers include a registration roller 71 for correcting the inclination of the sheet 900 and a loop roller 72 for forming a predetermined amount of loop on the sheet 900.

The sheet conveyance section 70 ejects the sheet 900 having an image formed thereon to a sheet ejection tray 90.

The working of the controller 110 will be described.

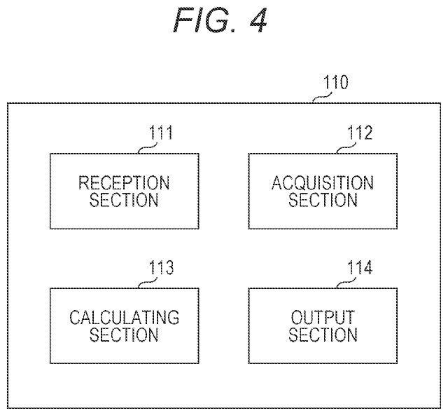

FIG. 4 is a block diagram illustrating functions of the controller 110. The controller 110 functions as a reception section 111, an acquisition section 112, a calculating section 113, and an output section 114. More specifically, the controller 110 constitutes a reception section 111 and an acquisition section 112 together with the communication section 130. The controller 110 constitutes the output section 114 together with the image forming section 170, the communication section 130, or the operation display section 140.

The acquisition section 112 acquires care-related information of a facility (hereinafter, simply referred to as “care-related information”) by receiving the care-related information by the communication section 130 or the like when a disaster occurs. Specifically, the acquisition section 112 acquires care-related information from the server 200 in response to the reception section 111 receiving information on the occurrence of a disaster. Disaster occurrence information may be information transmitted from a server or the like in an administrative office when a disaster occurs. Disasters include earthquakes, fires, and tsunamis.

When the disaster is an earthquake, the reception section 111 receives information on the occurrence of an earthquake, such as an emergency earthquake prompt report, as information on the occurrence of a disaster. In this case, the acquisition of the care-related information by the acquisition section 112 can be executed in response to the reception of the notification of the occurrence of the earthquake by the reception section 111 as a trigger.

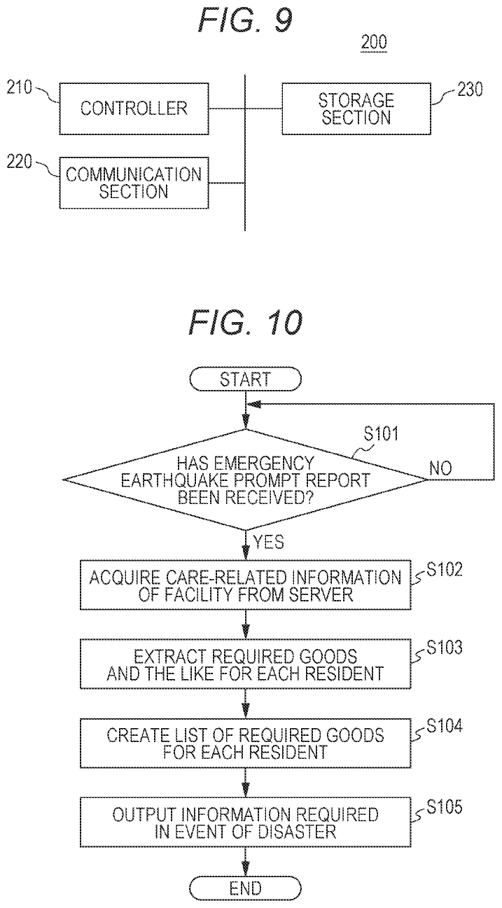

Care-related information can be information related to residents of a facility who receive care (hereinafter simply referred to as “residents”), care staff of the facility, and the like. Specifically, care-related information includes, for example, the name of the resident, the residential floor, the medication contents (medication name, medication frequency, last medication date and time, and the like), the staff in charge of care, the degree of independence, the necessity of toilet support, the evacuation order rank, and work shift information of the care-staff. The degree of independence is classified into four ranks, J, A, B, and C. The degree of independence indicates a so-called bedridden degree. In the case of the degree of independence, J indicates a self-standing state, A indicates a semi-bedridden state, and B and C indicate bedridden states. Care-related information is registered (including updating, the same applies hereinafter) in a database of a storage section 230 (see FIG. 9) of the server 200. The care staff is full-time or part-time staff who performs care (nursing care, nursing, training, and the like) of residents. Care-related information is registered in, for example, a resident table, a medication table, a diet table, and a work shift table. The acquisition section 112 can acquire a resident table, a medication table, a diet table, and a work shift table as care-related information.

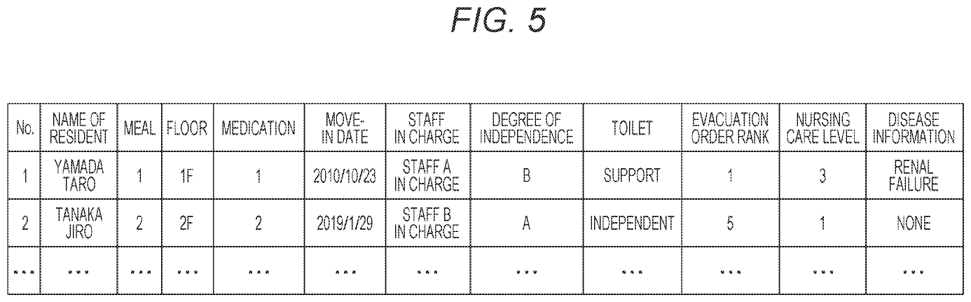

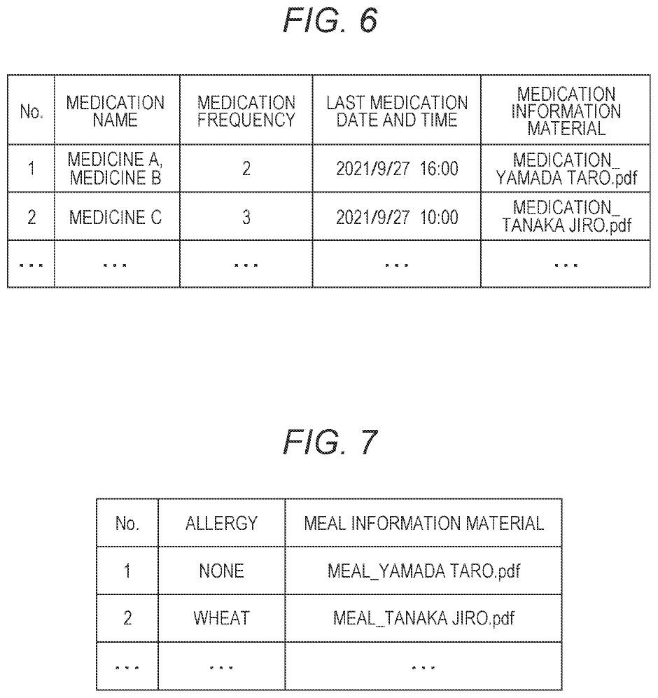

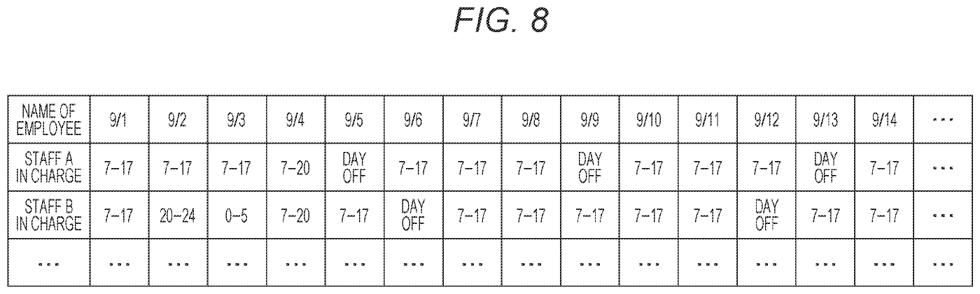

FIG. 5 is a diagram illustrating a resident table. FIG. 6 is a diagram illustrating a medication table. FIG. 7 is a diagram illustrating a diet table. The resident table, the medication table, and the diet table are associated with each other by a unique number assigned to each resident. FIG. 8 is a diagram showing a work shift table of care staff.

Information to be recorded in a resident table includes the names of residents, residential floors, staff in charge of care, the degrees of independence, the necessities of toilet support, evacuation order ranks, nursing care levels, and disease information. In the resident table, information such as move-in dates can be further registered. For example, the information registered in the resident table includes “Taro Yamada” as the name of a resident, “1F” as a residence floor, “Oct. 23, 2010” as a move-in date, and “staff A in charge” as staff in charge of care. For example, the information registered in the resident table includes “B” as the degree of independence, “support” as the necessity of toilet support, “1” is as an evacuation order rank, “nursing care level 3” a nursing care level, and “renal failure” as disease information.

In the medication table, medication contents (medication names, medication frequencies, and last medication dates and times) and the like are registered. Note that a prescription can be stored as a medication information material in the server 200 in association with the medication table. For example, the information registered in the medication table includes “medicine A and medicine B” as medication names, “2 (times/day)” as a medication frequency, and “16:00, Sep. 27, 2021” as a last medication date and time. In addition, a file of a prescription is registered as a medication information material.

The contents related to allergy (the presence or absence of allergies and food allergies) and the like are registered in the diet table. Note that, as a meal information material, a meal round record may be stored in the server 200 in association with the diet table. A meal round record is an information material in which cautions at the time of eating and observation results at the meal are recorded. In the diet table, for example, “wheat” is registered as information related to allergy. In addition, a file of a meal round record is registered as a meal information material.

The calculating section 113 calculates predetermined information required in the event of a disaster based on the care-related information. The calculation includes extracting part of the care information and calculating information based on the care-related information. What is set as the information required in the event of a disaster is registered by being previously stored in the storage section 120 as information minimally required in the event of a disaster. The information required in the event of a disaster can include at least one of the following: a nursing care level, a health condition, a disabling condition, and medication information of the resident. A health condition includes disease information and precautions at the time of a meal. A disabling condition includes the degree of independence.

The information required in the event of a disaster includes the information required in the event of a disaster regarding the entire facility and information required in the event of a disaster regarding each resident. The information required in the event of a disaster regarding the entire facility includes the number of each of articles necessary for the entire facility in the event of a disaster.

The information required in the event of a disaster regarding the entire facility includes, for example, the number of wheelchairs required for the entire facility, the number of diapers required for the entire facility for a predetermined period, and the types and numbers of medicines required for residents in the entire facility for a predetermined period, as required goods of the entire facility. The calculating section 113 can calculate the number of wheelchairs required for the entire facility as the sum of the numbers of residents whose degrees of independence (disabling conditions) are “B” and “C” from the resident table. The calculating section 113 can extract (calculate) the number of diapers required for the entire facility for a predetermined period as the number obtained by multiplying the number obtained by multiplying the sum of the numbers of residents whose degrees of independence are “A”, “B”, and “C” from the resident table by a predetermined period (e.g., 10 days assumed as an evacuation period) by a predetermined coefficient (e.g., the number selected from 2 to 5 assumed as the number of diapers required per day). The calculating section 113 can calculate, for each of the medication names registered in the medication table, the type and number of medications required for residents in the whole facility in a predetermined period by multiplying the sum of the medication frequencies of all the residents by a predetermined period (e.g., 10 days assumed as an evacuation period).

On the other hand, the information required in the event of a disaster regarding each resident includes, for example, a nursing care level, a health condition, a disabling condition, and medication information for each resident. The calculating section 113 may extract a nursing care level, the degree of independence, and disease information from the resident table. The calculating section 113 may extract medication information from the medication table. The calculating section 113 can extract, from the diet table, contents related to allergy as precautions at the time of a meal. Furthermore, the calculating section 113 can extract, from the meal information material, other precautions at the time of a meal, such as adding thickness to a soup.

The output section 114 outputs the information required in the event of a disaster extracted by the calculating section 113. The output includes forming an image of the information required in the event of a disaster on the sheet 900 by the image forming section 170 and ejecting the sheet and transmitting the information required in the event of a disaster to another apparatus or the like (including FAX transmission by a facsimile which is not illustrated). The output includes e-mail transmission (including transmission for backup to a cloud server) and displaying on the display of the operation display section 140. A recording medium on which an image is formed by the image forming section 170 is not limited to the sheet 900 and may be a resin film or the like.

The output section 114 may preferentially output the information required in the event of a disaster regarding a preferential resident over the information required in the event of a disaster regarding other residents with a point of view from at least one of (1) a resident to be cared by an off-duty worker at the time of a disaster, (2) the nursing care level, (3) the presence or absence of allergy, (4) the time until next medication, (5) the evacuation order rank, and (6) the health condition and the disabling condition. The output section 114 may determine the priority order of residents to which the information required in the event of a disaster is to be output by increasing the priority in the order of (1) a resident to be cared by an off-duty worker at the time of a disaster, (2) the nursing care level, (3) the presence or absence of allergy, (4) the time until next medication, and (5) the evacuation order rank. The output section 114 may output the information required in the event of a disaster regarding the residents in the determined priority order. For example, for a resident to be cared by an off-duty worker at the time of a disaster, since there is no staff in charge of the resident, there is a possibility that nobody knows in detail the information required in the event of a disaster regarding the resident, and there is a possibility that the information required in the event of a disaster regarding the resident cannot be output due to the disaster. Therefore, the output section 114 can output the information required in the event of a disaster regarding the resident to be cared by an off-duty worker at the time of a disaster more quickly.

The output section 114 can change the information required in the event of a disaster to be preferentially output, based on the type of disaster. The type of disaster can include at least either whether or not evacuation is necessary or an evacuation area. For example, in a case where the type of disaster indicates that evacuation is necessary (for example, in a case where the disaster is a fire in a facility), the output section 114 may preferentially output the information required in the event of a disaster regarding a resident on a residential floor (floor) that needs evacuation. In a case where the type of disaster indicates that evacuation is not necessary (for example, a fire in a building other than the facility), even the information required in the event of a disaster regarding the resident who uses a wheelchair does not needs to be output preferentially over the information required in the event of a disaster regarding the resident who does not use a wheelchair. In a case where the evacuation area corresponding to the disaster is the top floor (for example, in a case where the disaster is a tsunami), the output section 114 may preferentially output the information required in the event of a disaster regarding a resident whose residential floor is the 1F (first floor).

The output section 114 can change the method of outputting information required in the event of a disaster depending on the necessity of evacuation in the event of a disaster. For example, when evacuation is not necessary, the output section 114 may output information required in the event of a disaster by an output method of forming an image by the image forming apparatus 100 and outputting the image. When evacuation is necessary (e.g., when the disaster is a relatively large-scale fire in the facility), the output section 114 can output the information required in the event of a disaster by an output method of transmitting the information required in the event of a disaster to another cooperative facility, forming an image of the information required in the event of a disaster by an image forming apparatus in the other cooperative facility, and outputting the image.

(Server 200)

FIG. 9 is a block diagram illustrating the hardware configuration of a server 200. The server 20 includes a controller 210, a communication section 220, and the storage section 230, which are connected to each other via a bus.

The server 20 is configured by, for example, an on-premises server installed in a facility or the like or a cloud server.

The controller 210 includes a CPU, a RAM, and a ROM. The controller 210 controls each component of the server 20 and performs arithmetic processing in accordance with a program.

In response to a request from an image forming apparatus 100, the controller 210 transmits the resident table, the medication table, the diet table, and the work shift table of care staff stored in the storage section 230 to the image forming apparatus 100 via the communication section 220. The controller 210 can receive the information of the resident table, the medication table, the diet table, and the work shift table of the care staff by the communication section 220 and update the resident table, the medication table, the diet table, and the work shift table of the care staff stored in the storage section 230.

The communication section 220 includes an interface circuit for communicating with the image forming apparatus 100 and the like via the LAN.

The storage section 230 is formed from an HDD or SSD and stores various programs and various types of data. The storage section 230 stores a resident table, a medication table, a diet table, and a work shift table of care staff.

The operation of the image forming apparatus 100 will be described.

FIG. 10 is a flowchart showing the operation of the image forming apparatus 100. This flowchart can be executed by the controller 110 of the image forming apparatus 100 according to a program. This flowchart may be partially executed by the controller 210 of the server 20 according to the program.

The controller 110 determines whether an emergency earthquake prompt report has been received as disaster information by the communication section 130 (S101). Upon determining that an emergency earthquake prompt report has not been received (S101: NO), the controller 110 repeatedly executes step S101.

Upon determining that an emergency earthquake prompt report has been received (S101: YES), the controller 110 acquires care-related information from the server 20 (S102).

The controller 110 calculates required goods and the like for each resident from the care-related information (S103). The required goods can be, for example, wheelchairs, diapers, and medicines, as described above. The controller 110 extracts (calculates) required goods for each resident based on the resident table, the medication table, and the like. In addition, the controller 110 extracts (calculates) information required in the event of a disaster regarding each resident from the care-related information. The information required in the event of a disaster regarding each resident includes, for example, the nursing care level, the health condition, and the disabling condition of each resident as described above.

The controller 110 creates a list of required goods for each resident as a list of the extracted required goods and a spreadsheet (S104). The list of required goods for each resident includes, for example, the number of wheelchairs necessary for the entire facility, the number of diapers necessary for the entire facility in a predetermined period, and the type and number of medicines necessary for each resident in the entire facility in a predetermined period and constitutes information required in the event of a disaster regarding the entire facility.

The controller 110 outputs the calculated information required in the event of a disaster (S105). That is, the controller 110 outputs the information required in the event of a disaster regarding the entire facility and the information required in the event of a disaster regarding each resident.

Note that the controller 110 may periodically acquire the care-related information from the server 20 and store (and update) it in the storage section 120 regardless of whether or not an emergency earthquake prompt report has been received. In this case, step S103 and subsequent steps can be executed in response to the reception of the emergency earthquake prompt report.

The present embodiment has the following effects.

The care-related information of the facility is acquired, and predetermined information required in the event of a disaster is calculated and output from the care-related information. As a result, when a disaster occurs, it is possible to quickly secure the minimum necessary information for performing prioritized work, and to assist the continuity of the care service and quick evacuation.

In addition, the information required in the event of a disaster includes at least one of the following: a nursing care level, a health condition, a disabling condition, and medication information of the resident in the facility. This makes it possible to easily and appropriately ensure information that is highly likely to be required in the event of a disaster.

In addition, the information required in the event of a disaster regarding a preferential resident is preferentially output over the information required in the event of a disaster regarding other residents with a point of view from at least one of a resident to be cared by an off-duty worker at the time of a disaster, the nursing care level, the presence or absence of allergy, the time until next medication, the evacuation order rank, and the health condition and the disabling condition. As a result, in the event of a disaster, by outputting information of a resident having a higher degree of urgency first, it is possible to increase the possibility that information having a higher degree of urgency can be secured even if there is a possibility that information output becomes difficult.

Further, the information required in the event of a disaster to be preferentially output is changed based on the type of disaster. As a result, when a disaster occurs, it is possible to more safely secure the minimum necessary information for carrying out prioritized work.

In addition, the type of disaster includes at least either whether or not evacuation is necessary or an evacuation area. As a result, when a disaster occurs, it is possible to more safely and appropriately secure the minimum necessary information for carrying out prioritized work.

In addition, the method of outputting information required in the event of a disaster is changed depending on the necessity of evacuation in the event of a disaster. As a result, when a disaster occurs, it is possible to more safely secure the minimum necessary information for carrying out prioritized work.

Furthermore, the care-related information is acquired from the on-premise server or the cloud server. As a result, when a disaster occurs, it is possible to more safely and cheaply secure the minimum necessary information for carrying out prioritized work.

Furthermore, information on the occurrence of an earthquake is received, and the acquisition of care-related information is executed in response to the reception of the notification of the occurrence of the earthquake. As a result, when a disaster occurs, it is possible to more easily secure the minimum necessary information for carrying out prioritized work.

Further, the information required in the event of a disaster includes the number of each of articles necessary for the entire facility at the time of a disaster, a nursing care level, a health condition, a disabling condition, and medication information for each resident in the facility. As a result, when a disaster occurs, it is possible to more appropriately secure the minimum necessary information for carrying out prioritized work in an easily understandable manner.

Further, an information output system is used as an image forming apparatus, and information required in the event of a disaster is output by forming an image on a recording medium and outputting it. Thus, using an existing image forming apparatus or the like makes it possible to acquire, in an easily understandable format from an image, the minimum necessary information for performing a prioritized task in the event of a disaster.

Specifically, care-related information includes the name of the resident, the residential floor, medication contents, the staff in charge of care, the degree of independence, the necessity of toilet support, the evacuation order rank, and work shift information of the care-staff. This makes it possible to appropriately reduce the information for calculating information required in the event of a disaster.

The above-described configuration of the system has been described as a main configuration for describing the features of the above-described embodiment and is not limited to the above-described configuration, and various modifications can be made within the scope of the claims. For example, the above-described flowchart may include steps other than the steps shown in the flowchart or may not include some steps. Furthermore, the order of the steps is not limited to the above-described embodiment. Furthermore, each step may be combined with another step to be executed as one step, may be included in another step to be executed, or may be divided into a plurality of steps to be executed.

Furthermore, the means and method for performing various kinds of processing in the above-described embodiment can be implemented by either a dedicated hardware circuit or a programmed computer. The program may be provided by a computer-readable recording medium such as a USB memory or a digital versatile disc (DVD)-ROM or may be provided online via a network such as the Internet. In this case, the program recorded on the computer-readable recording media is usually transferred to a storage device such as a hard disk and stored therein. Furthermore, the program may be provided as a single piece of application software or may be incorporated as a function into software of the apparatus.

Although embodiments of the present invention have been described and illustrated in detail, the disclosed embodiments are made for purpose of illustration and example only and not limitation. The scope of the present invention should be interpreted by terms of the appended claims.

What is claimed is:

1. An information output system comprising:
an acquisition section that acquires care-related information of a facility; and
a hardware processor that calculates predetermined information required in the event of a disaster based on the acquired care-related information and causes an output section to output the calculated information required in the event of the disaster when the disaster occurs.

2. The information output system according to claim 1, wherein the information required in the event of the disaster includes at least one of a nursing care level, a health condition, a disabling condition, and medication information of the resident in the facility.

3. The information output system according to claim 2, wherein the hardware processor causes the output section to preferentially output the information required in the event of the disaster regarding the preferential resident over the information required in the event of the disaster regarding other residents with a point of view from at least one of a resident to be cared by an off-duty worker at the time of the disaster, the nursing care level, presence or absence of allergy, a time until next medication, an evacuation order rank, and the health condition and the disabling condition.

4. The information output system according to claim 1, wherein the hardware processor causes the output section to change the information required in the event of the disaster to be output preferentially based on a type of the disaster.

5. The information output system according to claim 4, wherein the type of disaster includes at least either whether or not evacuation is necessary or an evacuation area.

6. The information output system according to claim 1, wherein the hardware processor causes the output section to change a method of outputting the information required in the event of the disaster depending on whether or not evacuation is necessary in the event of the disaster.

7. The information output system according to claim 1, wherein the acquisition section acquires the care-related information from an on-premise server or a cloud server.

8. The information output system according to claim 1, wherein the disaster is an earthquake,
the system further comprises a reception section that receives information on occurrence of the earthquake, and
the care-related information is acquired by the acquisition section in response to reception of a notification of the occurrence of the earthquake.

9. The information output system according to claim 1, wherein the information required in the event of the disaster includes the number of each of articles necessary for the entire facility at the time of the disaster, a nursing care level, a health condition, a disabling condition, and medication information for each resident in the facility.

10. The information output system according to claim 1, wherein the information output system is an image forming apparatus, and
the hardware processor causes the output section to output the information required in the event of the disaster by forming an image on a recording medium and outputting the recording medium.

11. The information output system according to claim 1, wherein the care-related information includes a name of a resident, a residential floor, medication contents, staff in charge of care, a degree of independence, necessity of toilet support, an evacuation order rank, and work shift information of care-staff.

12. An information output method comprising:
a step (a) of acquiring care-related information of a facility;
a step (b) of calculating predetermined information required in the event of a disaster based on the acquired care-related information; and
a step (c) of outputting the calculated information required in the event of the disaster when the disaster occurs.

13. The information output method according to claim 12, wherein the information required in the event of the disaster includes at least one of a nursing care level, a health condition, a disabling condition, and medication information of the resident in the facility.

14. The information output method according to claim 13, wherein in the step (c), the information required in the event of the disaster regarding the preferential resident is preferentially output over the information required in the event of the disaster regarding other residents with a point of view from at least one of a resident to be cared by an off-duty worker at the time of the disaster, the nursing care level, presence or absence of allergy, a time until next medication, an evacuation order rank, and the health condition and the disabling condition.

15. The information output method according to claim 12, wherein in the step (c), the information required in the event of the disaster to be output preferentially is changed based on a type of the disaster.

16. The information output method according to claim 15, wherein the type of disaster includes at least either whether or not evacuation is necessary or an evacuation area.

17. The information output method according to claim 12, wherein in the step (c), a method of outputting the information required in the event of the disaster is changed depending on whether or not evacuation is necessary in the event of the disaster.

18. The information output method according to claim 12, wherein the care-related information is acquired from an on-premise server or a cloud server.

19. The information output method according to claim 12, wherein the disaster is an earthquake,
the method further comprises a step (d) of receiving information on occurrence of the earthquake, and
the acquisition of the care-related information in the step (a) is executed in response to reception of a notification of the occurrence of the earthquake.

20. The information output method according to claim 12, wherein the information required in the event of the disaster includes the number of each of articles necessary for the entire facility at the time of the disaster, a nursing care level, a health condition, a disabling condition, and medication information for each resident in the facility.

21. The information output method according to claim 12, wherein the method is executed by an image forming apparatus, and
in the step (c), the information required in the event of the disaster is output by forming an image on a recording medium and outputting the recording medium.

22. The information output method according to claim 12, wherein the care-related information includes a name of a resident, a residential floor, medication contents, staff in charge of care, a degree of independence, necessity of toilet support, an evacuation order rank, and work shift information of care-staff.

23. A computer-readable non-transitory recording medium storing an information output program for causing a computer to execute
acquiring care-related information of a facility,
calculating predetermined information required in the event of a disaster based on the acquired care-related information; and
outputting the calculated information required in the event of the disaster when the disaster occurs.
